(19) United States
(12) Patent Application Publication
(10) Pub. No.: US 2007/0030147 A1
(43) Pub. Date: Feb. 8, 2007

(54) Neverlost Keychain

(76) Inventor: Sharon Lee Hamolsky, Solana Beach, CA (US)

Correspondence Address: Sharon Hamolsky, 103 Matamoros Court, Solana Beach, CA, 92075, US

(21) Appl. No.: 11/161,572

(22) Filed: Aug. 8, 2005

(51) Int. Cl. H04Q 7/00

(52) U.S. Cl. 340/539.32

(57) ABSTRACT

Devices for locating misplaced keys are described. Such devices include a housing in which is disposed a cell phone receiver, a ringer, associated circuitry, a power supply, and an “on/off” switch”. Such devices may also include a battery life indicator disposed in the housing, which indicator is visible to a user.

### FIELD OF THE INVENTION

This invention relates to electronic devices, particularly to electronic devices useful for locating misplaced keys.

### BACKGROUND OF THE INVENTION

This invention provides a solution for the problem of misplaced keys and keychains.

### SUMMARY OF THE INVENTION

The invention concerns keychain locators. Such locators include a housing that houses the device electronics, a ringer to produce ringing sounds, and battery-based power supply. The device also includes an “on/off” switch accessible through the housing, and in some embodiments, an indicator showing battery life. The electronics include a cell phone receiver and associated circuitry. The cell phone receiver has a cell phone number assigned to it. When the cell phone receiver receives an interrogation including its associated phone number, the electronics actuate the ringer to produce a ringing sound to enable the user to locate the keychain.

### BRIEF DESCRIPTION OF THE DRAWINGS

FIG. 1 is an illustration showing an internal view of a device according to the invention.

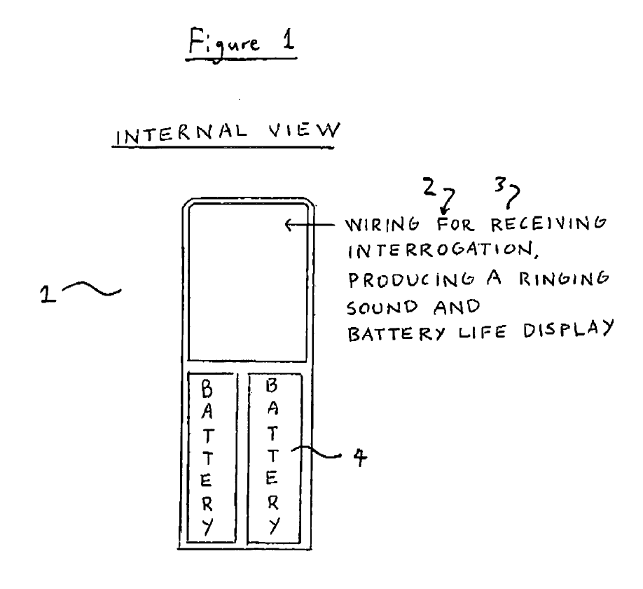

FIG. 2 is an illustration showing an internal view of a device according to the invention.

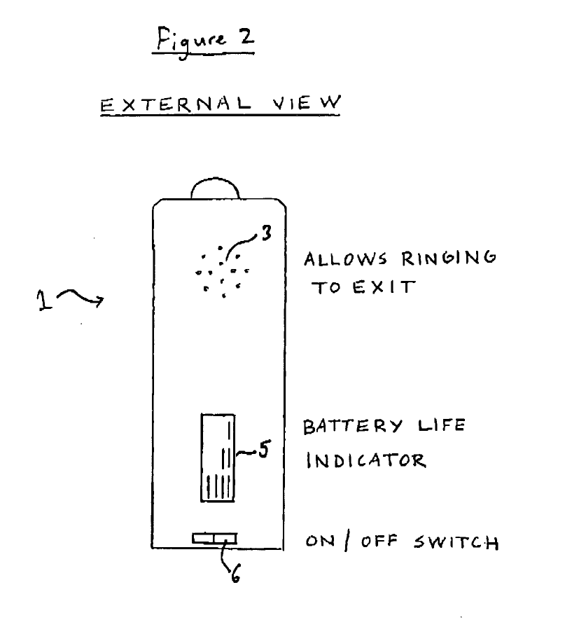

### DETAILED DESCRIPTION OF THE INVENTION

A keychain (1) which houses a cell phone receiver (2) and ringer (3). The keychain will have a phone number associated with it. If you misplace the keychain, you will call the number, the keychain will ring and you will be able to locate it. It will be battery powered (4) with an indicator (5) to show battery life. It has an “on/off” switch (6) by which a user can turn the device “on” and “off”.

What is claimed is:

1. A keychain locator, consisting essentially of:
a cell phone receiver programmed to receive an incoming telephone interrogation on an associated telephone number and actuate a ringer to produce a sound upon receipt of a telephone interrogation to the associated telephone number;
a ringer for producing a ringing sound upon receipt of a telephone interrogation to the associated telephone number;
a power supply connected to the cell phone receiver and ringer;
a housing for housing the cell phone receiver, a ringer, and a power supply; and
an “on/off” switch to turn the device “on” and “off”.

2. A keychain locator, consisting essentially of:
a cell phone receiver programmed to receive an incoming telephone interrogation on an associated telephone number and actuate a ringer to produce a sound upon receipt of a telephone interrogation to the associated telephone number;
a ringer for producing a ringing sound upon receipt of a telephone interrogation to the associated telephone number;
a power supply connected to the cell phone receiver and ringer;
a housing for housing the cell phone receiver, ringer, and power supply, and a battery life indicator visible to a user; and
an “on/off” switch to turn the device “on” and “off”.
